(19) United States
(12) Patent Application Publication
(10) Pub. No.: US 2014/0361756 A1
(43) Pub. Date: Dec. 11, 2014

(54) POWER SUPPLY CIRCUIT

(71) Applicant: HON HAI PRECISION INDUSTRY CO., LTD., New Taipei (TW)

(72) Inventors: HUNG-YI WANG, New Taipei (TW); HSIANG-PIN TSENG, New Taipei (TW)

(73) Assignee: HON HAI PRECISION INDUSTRY CO., LTD., New Taipei (TW)

(21) Appl. No.: 14/256,354

(22) Filed: Apr. 18, 2014

(30) Foreign Application Priority Data
Jun. 7, 2013 (TW) 102120227

(51) Int. Cl. H02M 3/158

(52) U.S. Cl. CPC H02M 3/158
USPC 323/282

(57) ABSTRACT

Power supply circuit includes a voltage converting circuit and a comparing circuit. The voltage converting circuit includes a PWM controller and a plurality of transistors connected therewith. The voltage converting circuit is configured to switch on or off the plurality of transistors alternately and outputting a voltage signal with a ripple. The comparing circuit is connected to the PWM controller and configured to compare a peak voltage of the ripple with a threshold value. When the peak voltage is not greater than the threshold value, the comparing circuit outputs a first signal to the PWM controller, and the PWM controller decreases a switch frequency of the plurality of transistors. When the peak voltage is greater than the threshold value, the comparing circuit outputs a second signal to the PWM controller, and the PWM controller increases the switch frequency of the plurality of transistors.

### FIELD

The present disclosure relates to a power supply circuit.

### BACKGROUND

A typical power supply circuit for supplying a working voltage to a CPU includes a PWM controller, at least one pair of MOSFETs connected to the PWM controller, inductors, and capacitors. The PWM controller switches on or off the pair of MOSFETs alternately according to predefined PWM signals, thereby controlling a voltage value of a voltage signal by the power supply circuit. The voltage signal usually has a ripple. The greater the switching frequency of the pair of MOSFETs, the smaller the peak value of the ripple. However, when the switching frequency of the pair of MOSFETs increased, so does the power consumption.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a power supply circuit.

FIG. 2 is a detailed circuit of the power supply circuit of FIG. 1.

### DETAILED DESCRIPTION

The disclosure is illustrated by way of example and not by way of limitation in the figures of the accompanying drawings in which like references numerals indicate similar elements. It should be noted that references to “an” or “one” embodiment in this disclosure are not necessarily to the same embodiment, and such references mean “at least one.”

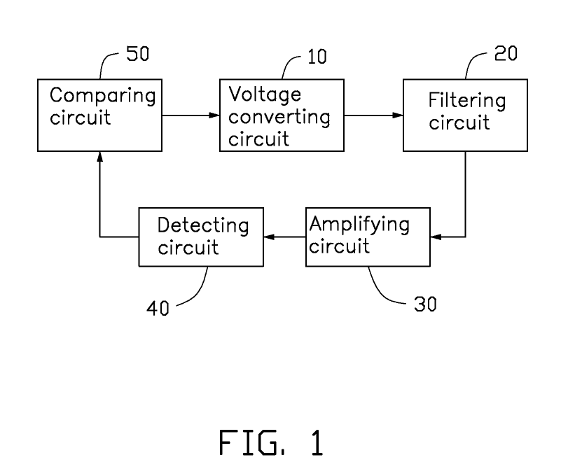

FIG. 1 illustrates an embodiment of a power supply circuit that includes a voltage converting circuit 10, a filtering circuit 20, an amplifying circuit 30, a detecting circuit 40, and a comparing circuit 50. In one embodiment, the power supply circuit is configured to supply a working voltage to a CPU.

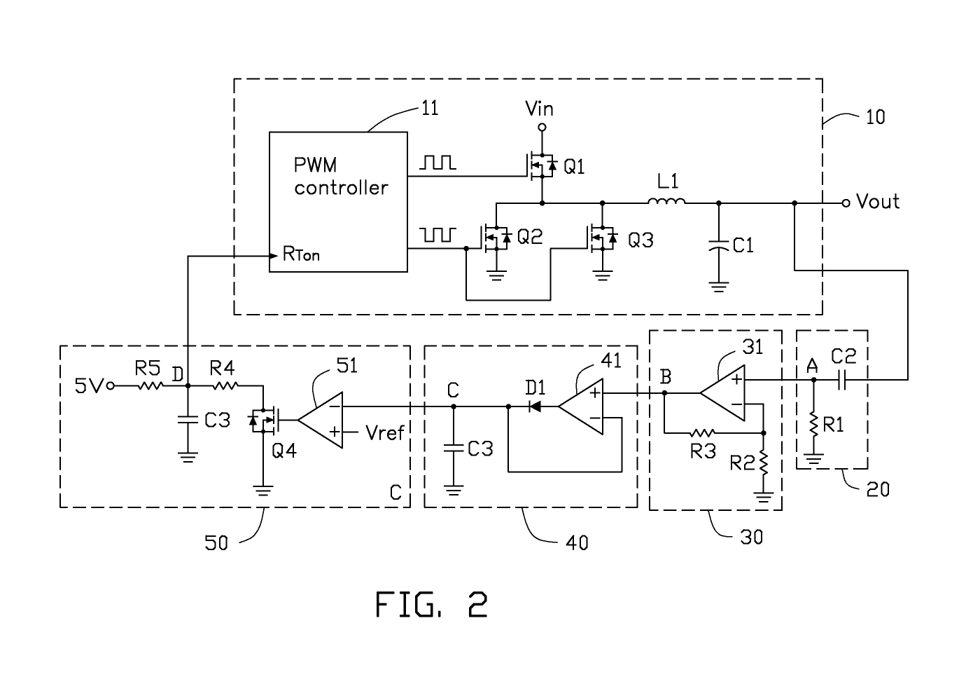

FIG. 2 shows the voltage converting circuit 10 that includes a PWM controller 11, a first transistor Q1, a second transistor Q2, a third transistor Q3, an inductor L1, and a capacitor C1. A gate terminal of the first transistor Q1 is connected to the PWM controller 11. A drain terminal of the first transistor Q1 is coupled to a power supply Vin. A source terminal of the first transistor Q1 is connected to drain terminals of the second transistor Q2 and the third transistor Q3. A gate terminal of each of the second transistor Q2 and the third transistor Q3 is connected to the PWM controller 11. A source terminal of each of the second transistor Q2 and the third transistor Q3 is connected to ground. One terminal of the inductor L1 is connected to the source terminal of the first transistor Q1, and the other terminal of the inductor L1 is connected to a voltage output terminal Vout of the voltage converting circuit 10. One terminal of the capacitor C1 is connected to the voltage output terminal Vout, and the other terminal of the capacitor C1 is connected to ground. In one embodiment, each of the first transistor Q1, the second transistor Q2, and the third transistor Q3 is an N-channel MOSFET.

The filtering circuit 20 includes a second capacitor C2 and a first resistor R1. One terminal of the second capacitor C2 is connected to the voltage output terminal Vout, and the other terminal of the second capacitor C2 is connected to a node A. One terminal of the first resistor R1 is connected to the node A, and the other terminal of the first resistor R1 is connected to ground.

The amplifying circuit 30 includes a first amplifier 31, a second resistor R2, and a third resistor R3. A positive input terminal of the first amplifier 31 is connected to the node A. A negative input terminal of the first amplifier 31 is connected to ground via the second resistor R2. One terminal of the third resistor R3 is connected to the negative input terminal of the first amplifier 31, and the other terminal of the third resistor R3 is connected to an output terminal of the first amplifier 31. The output terminal of the first amplifier 31 is connected to a node B.

The detecting circuit 40 includes a second amplifier 41, a diode D1, and a third capacitor C3. A positive input terminal of the second amplifier 41 is connected to the node B. The negative input terminal of the second amplifier 41 is connected to a node C. A positive terminal of the diode D1 is connected to the output terminal of the second amplifier 41. A negative terminal of the diode D1 is connected to the node C. One terminal of the third capacitor C3 is connected to the node C, and the other terminal of the third capacitor C3 is connected to ground.

The comparing circuit 50 includes a third amplifier 51, a fourth transistor Q4, a fourth resistor R4, a fifth resistor R5, and a fourth capacitor C4. A negative input terminal of the third amplifier 51 is connected to the node C. A positive input terminal of the third amplifier 51 is coupled to a reference voltage Vref. An output terminal of the third amplifier 51 is connected to a gate terminal of the fourth transistor Q4. A drain terminal of the fourth transistor Q4 is connected to a node D via the fourth resistor R4. A source terminal of the fourth transistor Q4 is connected to ground. One terminal of the fifth resistor R5 is connected to the node D, and the other terminal of the fifth resistor R5 is coupled to a power supply (5V). One terminal of the fourth capacitor C4 is connected to the node D, and the other terminal of the fourth capacitor C4 is connected to ground. The node D is connected to a pin RTon of the PWM controller 11. In one embodiment, the fourth transistor Q4 is an N-channel MOSFET.

When the power supply circuit is powered on, the PWM controller 11 switches on or off the first transistor Q1, the second transistor Q2, and the third transistor Q3 according to a predetermined switching frequency. An on or off state of the second transistor Q2 is opposite to that of the first transistor Q1, but the same as that of the third transistor Q3. The inductor L1 and the first capacitor C1 are energized and output a voltage signal with a ripple via the voltage output terminal Vout. The voltage signal is filtered by the filtering circuit 20. The filtering circuit 20 outputs the ripple of the voltage signal to the amplifying circuit 30. The ripple is amplified by the amplifying circuit 30. The amplifying circuit 30 outputs the amplified ripple to the detecting circuit 40 via the node B. The detecting circuit 40 detects a peak voltage of the ripple and outputs the peak voltage to the negative input terminal of the third amplifier 51 via the node C.

If the peak voltage of the ripple is not greater than the reference voltage Vref, the output terminal of the third amplifier 51 outputs a high level signal to the gate terminal of the fourth transistor Q4. The fourth transistor Q4 is switched on. The node D has a first voltage when the fourth transistor Q4 is switched on. The PWM controller 11 decreases the switching frequency of the first transistor Q1, the second transistor Q2, and the third transistor Q3 until the peak voltage exceeds the reference voltage Vref. The first transistor Q1, the second transistor Q2, and the third transistor Q3 consumes less power when the switching frequency is decreased.

If the peak voltage of the ripple is greater than the reference voltage Vref, the output terminal of the third amplifier 51 outputs a low level signal to the gate terminal of the fourth transistor Q4. The fourth transistor Q4 is switched off. The node D has a second voltage that is greater than the first voltage. The PWM controller 11 receives the second voltage signal and increases the switching frequency of the first transistor Q1, the second transistor Q2, and the third transistor Q3 until the peak voltage become less than the reference voltage Vref. The peak voltage of the ripple is decreased when the switching frequency of the first transistor Q1, the second transistor Q2, and the third transistor Q3 is increased.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A power supply circuit comprising:
a voltage converting circuit comprising a PWM controller, a first transistor connected to the PWM controller, and a second transistor connected to the PWM controller; the voltage converting circuit configured to switch on and off the first transistor and the second transistor alternately and output a voltage signal with a ripple; an on or off state of the first transistor being opposite to that of the second transistor;
a comparing circuit, connected to the PWM controller, and configured to compare a peak voltage of the ripple with a threshold value;
wherein when the peak voltage of the ripple is not greater than the threshold value, the comparing circuit outputs a first signal to the PWM controller, and the PWM controller decreases a switch frequency of the first transistor and the second transistor;
and when the peak voltage of the ripple is greater than the threshold value, the comparing circuit outputs a second signal to the PWM controller, and the PWM controller increases the switch frequency of the first transistor and the second transistor.

2. The power supply circuit of claim 1, further comprising a filtering circuit connected to an output terminal of the voltage converting circuit for filtering the voltage signal.

3. The power supply circuit of claim 2, wherein the filtering circuit comprises a first resistor and a second capacitor, a first terminal of the second capacitor is connected to the output terminal of the voltage converting circuit, a second terminal of the second capacitor is connected to a first node; a first terminal of the first resistor R1 is connected to the first node, and a second terminal of the first resistor R1 is connected to ground.

4. The power supply circuit of claim 3, further comprising an amplifying circuit connected to the first node for amplifying the ripple.

5. The power supply circuit of claim 4, wherein the amplifying circuit comprises a first amplifier, a second resistor, and a third resistor, a positive input terminal of the first amplifier is connected to the first node, a negative input terminal of the first amplifier is connected to ground via the second resistor, and an output terminal of the first amplifier is connected to a second node; a first terminal of the third resistor is connected to the second node, and a second terminal of the third resistor is connected to the negative input terminal.

6. The power supply circuit of claim 5, further comprising a detecting circuit connected to the second node, wherein the amplifying circuit is capable of outputting an amplified ripple to the detecting circuit, and the detecting circuit is capable of detecting the peak voltage of the amplified voltage.

7. The power supply circuit of claim 6, wherein the detecting circuit comprises a second amplifier, a diode, and a third capacitor; a positive input terminal of the second amplifier is connected to the second node, the negative input terminal of the second amplifier is connected to a third node; a positive terminal of the diode is connected to the output terminal of the second amplifier, the negative terminal of the diode is connected to the third node; a first terminal of the third capacitor is connected to the third node, and a second terminal of the third capacitor is connected to ground.

8. The power supply circuit of claim 7, wherein the comparing circuit comprises a third amplifier, a negative input terminal of the third amplifier is connected to the third node, a positive input terminal of the third amplifier is coupled to a reference voltage, and an output terminal of the third amplifier is connected to the PWM controller.

9. The power supply circuit of claim 8, wherein the comparing circuit further comprises a fourth transistor, a fourth resistor, and a fifth resistor, the output terminal of the third amplifier is connected to a gate terminal of the fourth transistor, a drain terminal of the fourth transistor is connected to a fourth node via the fourth resistor, and a source terminal of the fourth transistor is connected to ground; a first terminal of the fifth resistor is connected to a power supply, a second terminal of the fifth resistor is connected to the fourth node; the comparing circuit is capable of outputting the first signal or the second signal to the PWM controller via the fourth node.

10. The power supply circuit of claim 1, wherein the voltage converting circuit further comprises a third transistor connected to the PWM controller, and an on or off state of the third transistor is the same as that of the second transistor, but opposite to that of the first transistor.

11. A power supply circuit comprising:
a voltage converting circuit comprising a PWM controller and a plurality of transistors connected to the PWM controller; the voltage converting circuit configured to switch on and off the plurality of transistors and outputting a voltage signal with a ripple; a switching frequency of each of the plurality of transistors is the same as each other;
a comparing circuit, connected to the PWM controller, and configured to compare a peak voltage of the ripple with a threshold value;
wherein when the peak voltage of the ripple is not greater than the threshold value, the comparing circuit outputs a first signal to the PWM controller, and the PWM controller decreases the switch frequency of the plurality of transistors; and when the peak voltage of the ripple is greater than the threshold value, the comparing circuit outputs a second signal to the PWM controller, and the PWM controller increases the switch frequency of the plurality of transistors.

12. The power supply circuit of claim 11, further comprising a filtering circuit connected to an output terminal of the voltage converting circuit for filtering the voltage signal.

13. The power supply circuit of claim 12, wherein the filtering circuit comprises a first resistor and a second capacitor, a first terminal of the second capacitor is connected to the output terminal of the voltage converting circuit, a second terminal of the second capacitor is connected to a first node; a first terminal of the first resistor R1 is connected to the first node, and a second terminal of the first resistor R1 is connected to ground.

14. The power supply circuit of claim 13, further comprising an amplifying circuit connected to the first node for amplifying the ripple.

15. The power supply circuit of claim 14, wherein the amplifying circuit comprises a first amplifier, a second resistor, and a third resistor, a positive input terminal of the first amplifier is connected to the first node, a negative input terminal of the first amplifier is connected to ground via the second resistor, and an output terminal of the first amplifier is connected to a second node; a first terminal of the third resistor is connected to the second node, and a second terminal of the third resistor is connected to the negative input terminal.

16. The power supply circuit of claim 15, further comprising a detecting circuit connected to the second node, wherein the amplifying circuit is configured to output an amplified ripple to the detecting circuit, and the detecting circuit is configured to detect the peak voltage of the amplified voltage.

17. The power supply circuit of claim 16, wherein the detecting circuit comprises a second amplifier, a diode, and a third capacitor; a positive input terminal of the second amplifier is connected to the second node, the negative input terminal of the second amplifier is connected to a third node; a positive terminal of the diode is connected to the output terminal of the second amplifier, the negative terminal of the diode is connected to the third node; a first terminal of the third capacitor is connected to the third node, and a second terminal of the third capacitor is connected to ground.

18. The power supply circuit of claim 17, wherein the comparing circuit comprises a third amplifier, a negative input terminal of the third amplifier is connected to the third node, a positive input terminal of the third amplifier is coupled to a reference voltage, and an output terminal of the third amplifier is connected to the PWM controller.

19. The power supply circuit of claim 18, wherein the comparing circuit further comprises a fourth transistor, a fourth resistor, and a fifth resistor, the output terminal of the third amplifier is connected to a gate terminal of the fourth transistor, a drain terminal of the fourth transistor is connected to a fourth node via the fourth resistor, and a source terminal of the fourth transistor is connected to ground; a first terminal of the fifth resistor is connected to a power supply, a second terminal of the fifth resistor is connected to the fourth node; the comparing circuit is capable of outputting the first signal or the second signal to the PWM controller via the fourth node.

20. The power supply circuit of claim 11, wherein the plurality of transistors comprises a first transistor, a second transistor, and a third transistor; an on or off state of the second transistor is the same as that of the third transistor, but opposite to that of the first transistor.
